(19) United States
(12) Patent Application Publication
(10) Pub. No.: US 2008/0186699 A1
(43) Pub. Date: Aug. 7, 2008

(54) Task Light System

(75) Inventors: Manuel Saez, Brooklyn, NY (US); Stefan Spoerl, New York, NY (US); Jonathan Puleio, Forest Hills, NY (US)

Correspondence Address: JONES, WALKER, WAECHTER, POITEVENT, CARRERE;& DENEGRE, L.L.P., 5TH FLOOR, FOUR UNITED PLAZA, 8555 UNITED PLAZA BOULEVARD, BATON ROUGE, LA, 70809, US

(73) Assignee: Humanscale Corporation, New York, NY (US)

(21) Appl. No.: 11/670,767

(22) Filed: Feb. 2, 2007

(51) Int. Cl. F21S 2/00

(52) U.S. Cl. 362/191; 362/368; 362/277; 362/282; 362/341; 362/371; 362/370; 362/640

(57) ABSTRACT

A task light system for mounting to a computer component, including a housing with an aperture, a light source, and a mounting structure such that light escapes to illuminate a workspace when desired and levels of light may be adjusted. The task light system of the present invention also includes embodiments with mechanical and electronic light level controls for customizable workplace lighting.

### I. CROSS-REFERENCE TO RELATED APPLICATION

Not Applicable.

### II. STATEMENT REGARDING FEDERALLY SPONSORED RESEARCH OR DEVELOPMENT

Not Applicable.

### III. FIELD OF THE INVENTION

The present invention relates to task light systems for the illumination of task spaces near computer components within the workplace.

### IV. BACKGROUND OF THE INVENTION

The largest lighting issue facing office workers today is an office lit exclusively with overhead lights, which evenly illuminate the entire workplace—walls, desktops, floors, cabinets, etc. The problem with this approach is that different users and different tasks require vastly different amounts of light. For example, reading a paper-based document requires four to five times more light than does viewing a visual display terminal (i.e., computer monitor). Referencing a phone book or viewing moderately detailed photographs requires ten times more light than does viewing a liquid crystal display (LCD) monitor. Moreover, as workers age, the relative contrast required for all tasks increases. Accordingly, a 60 year old worker reading a paper document will need substantially more light than a 20 year old viewing a computer monitor. The number one health related complaint of office workers is eyestrain, and most workers request better lighting in the workplace.

In order to address eye-related problems in the workplace, task lights have been developed to allow users to direct light where they need it most, i.e., onto paper documents, and away from areas where they do not (i.e., computer monitors). A proper task light should be constructed and oriented to avoid screen glare from computer monitors and to avoid direct light into the user's eyes. Further, adjustable task lights give the user maximum control of the level of light such that each worker may achieve optimal comfort, allowing each to compensate for fluctuations within his visual acuity from time to time, as well as for variations in ambient lighting. Recent prior art task light systems generally consist of traditional lamps like that described in U.S. Pat. No. 6,089,724 (Shore et al.), which supply indirect lighting to task areas using a reflective visor (or shade). Although this lamp attempts to reduce both direct glare and reflective glare from computer monitors while still providing an illuminated workspace, the lamp illuminates a relatively large task area such as a horizontal desk.

The present invention overcomes these and other disadvantages of prior task light systems by providing an improved task light system that targets light upon specific areas near a computer monitor that may need further illumination without altering light levels in other areas of a worker's task zone. The worker's task zone is the work area in an office or office-like environment, including within the home, which may contain a variety of structural devices such as a computer monitor, computer processing unit, keyboard, desk, and the like. Such an improved task light system avoids any reflective glare, direct glare or direct light into a user's eyes, and preferably utilizes low levels of power such that temperature and cost are minimized. The present invention also provides a task light system that adjusts positioning to be used with a variety of tasks within the worker's task zone. The improved task light system of the present invention further provides a mounting structure for securing the system to a computer component in a manner that provides easy visibility of illuminated areas by a worker while working with an illuminated display associated with a computer.

### V. BRIEF DESCRIPTION OF THE INVENTION

In one embodiment, the present invention provides a housing having at least one aperture; a light means positioned within the housing adjacent the aperture; a mounting means wherein the mounting means operably engages the housing and is adapted to be removably attached to a structural device in a worker's task zone.

In another embodiment, the present invention provides a light control means operably engaged to the light means. In yet another embodiment, the light control means comprises a cover movably connected to the housing, and the cover may be moved to eclipse the aperture in any segment of the range from zero percent to one-hundred percent. In one such embodiment, the cover may rotate about the housing. In related embodiments, the light control means may comprise a potentiometer or a microprocessor. In yet other embodiments, the user may adjust the light level using a graphic user interface (GUI).

In yet other embodiments, the present invention provides a light means comprising one or more fluorescent light bulbs, which may comprise one or more cold cathode fluorescent light bulbs or one or more light emitting diodes. Another embodiment provides a light source with a color temperature in the range from approximately 3000 Kelvins to approximately 6000 Kelvins, or an illuminance value in the range from approximately 50 foot candles to approximately 200 foot candles. In certain embodiments, the housing may include a reflective interior surface. In another embodiment, the present invention provides a power source operably engaged to the light source. In such embodiments, the power source may be external to the housing. In certain embodiments, the power source may convert alternating current to direct current. The power source may also comprise a computer component, in which the power source may be supplied by the computer component through a universal serial bus (USB) port, may be delivered through the conversion of solar energy to electrical power, or may be supplied by one or more batteries.

In one embodiment, the present invention provides a mounting means to secure the task light system to a computer component, including a monitor, a central processing unit, a support for a monitor, a support for a central processing unit, a desk and other items within a worker's task zone capable of supporting a task light system.

In another embodiment, the present invention provides an engagement means to secure or releasably secure the housing to the mounting means. In other embodiments, the engagement means comprises a flexible ball joint adapted to secure the housing to the mounting means. In other embodiments, the engagement means may rotatably secure the housing to the mounting means. In yet other embodiments, the mounting means further provides inner and outer frame members and a locking adjustment means to adjust the width of the task light system. In some embodiments, the adjustment means may include a knob for tightening the frame members.

In yet another embodiment, the mounting means may include frame members with a connector means to adjust the width of the task light system. In such embodiments, the connector means may include a ratchet connector operably engaged to saw tooth edges along the interior of frame members such that the width of the task light system may be adjusted. In other embodiments, a knob may engage with the ratchet connector.

In one embodiment, the present invention provides for an adjustment means including a spring button and a reset knob, to allow movement of frame members to increase or decrease the width of the task light system. In other embodiments, the adjustment means may include a switch.

In yet another embodiment, the present invention provides for a mounting means comprising at least two members spring-mounted to the housing and capable of exacting opposing forces such that a compression force secures the task light system to a computer component. In another embodiment, the present invention provides for a mounting means comprising at least one connector member movably attached to a mounting clamp. In such embodiments, the connector member may comprise two disks fixed together and rotatable in substantially opposing directions. The connector member or members may engage and articulate the housing and the mounting clamp relative to each other, and an arm member may be included to provide for an extension from the mounting clamp to the connector members and the housing. In these embodiments, the mounting clamp may secure the task light system to a monitor, central processing unit, support for a monitor, support for a central processing unit, a desk and the like.

In one embodiment, the present invention provides a task light system, comprising (a) a housing with an aperture; (b) at least one light source within the housing and adjacent the aperture, and (c) a mounting structure, wherein the mounting structure engages the housing. In another embodiment, the present invention may further provide a light controller operably engaged to the light source. In such embodiments, the light controller may comprise a cover, and may be movably connected to the housing such that it may eclipse the aperture in any segment of the range from zero percent to one-hundred percent. In other embodiments, the cover may rotate about the housing. The light controller may comprise a potentiometer or a microprocessor. A user may adjust the light level using a graphic user interface.

In one embodiment, the present invention provides a light source comprising one or more fluorescent light bulbs, including cold cathode fluorescent light bulbs, or one or more light emitting diodes. In another embodiment, the present invention provides a light source with color temperature range from approximately 3000 Kelvins to approximately 6000 Kelvins, or an illuminance in the range from approximately 50 foot candles to approximately 200 foot candles. The housing may further include a reflective interior surface.

In another embodiment, the present invention provides a mounting structure that includes adhesive.

In another embodiment, the present invention provides a task light system kit comprising (a) a plurality of interchangeable mounting structures and (b) a light source adapted to be removably attached to one of the plurality of interchangeable mounting structures, wherein the plurality of interchangeable mounting structures are adapted to removably attach the light source to a structural device in the worker's task zone. In some embodiments, the task light system kit may comprise a universal serial bus (USB) cable to connect the light source to a computer component's USB port, or graphical user interface software adapted to allow a user to adjust the power supplied to the computer component's USB port.

In yet another embodiment, the present invention provides a task light system kit comprising (a) a mounting structure and (b) a plurality of interchangeable light sources adapted to be removably attached to the mounting structure, wherein the plurality of interchangeable light sources are adapted to provide adequate lighting for a variety of tasks in the worker's task zone. In some embodiments, the task light system kit may comprise a universal serial bus (USB) cable to connect the light source to a computer component's USB port, or graphical user interface software adapted to allow a user to adjust the power supplied to the computer component's USB port.

The above description of the present invention is not intended to describe each illustrated embodiment or every possible implementation of the present invention. The figures and the detailed description which follow, however, do particularly exemplify these embodiments.

### VI. BRIEF DESCRIPTION OF THE DRAWINGS

In consideration of the following detailed description of various embodiments of the invention, the invention may be more completely understood in connection with the accompanying drawings:

FIG. 1 is an exploded front view of an embodiment of the present invention.

FIG. 2 is an exploded bottom view of an embodiment of the present invention.

FIG. 3(a) is a front view of an embodiment of the present invention, including an embodiment with an articulating arm.

FIG. 3(b) is a schematic of an embodiment of the present invention, including an embodiment with an articulating arm.

FIG. 4(a) is a bottom view of an embodiment of the present invention, including an embodiment with an articulating arm and a top.

FIG. 4(b) is a top magnified view of an embodiment of a mounting structure of the present invention.

FIGS. 5(a)-5(c) are front, top and side views of an embodiment of a mounting structure of the present invention.

FIGS. 6(a)-6(c) are front, perspective and alternate front views of an embodiment of a mounting structure of the present invention.

FIGS. 7(a)-7(c) are schematic drawings of embodiments of a mounting structure of the present invention.

FIGS. 8(a)-(c) are bottom, top and back views of an embodiment of a housing of the present invention.

FIG. 9(a) is an exploded view of an embodiment of the present invention.

FIG. 9(b) is a cross-sectional view of an embodiment of a housing of the present invention.

FIG. 9(c) is a schematic drawing of an embodiment of a light source of the present invention.

FIG. 9(d) is a schematic drawing of an embodiment of a housing of the present invention.

FIG. 9(e) is a schematic drawing of an embodiment of a cover of the present invention.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention as defined by the appended claims.

### VII. DETAILED DESCRIPTION OF THE DESCRIBED EMBODIMENTS

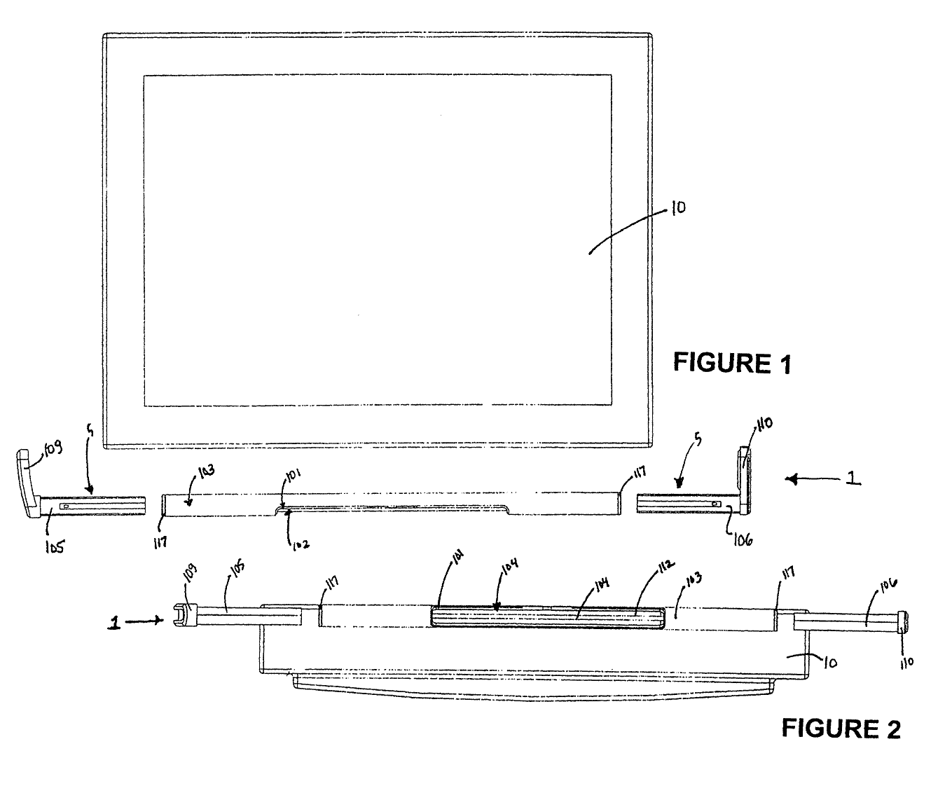

An embodiment of the present invention is generally illustrated in FIG. 1. Task light system 1 is shown mounted upon, and in combination with, a computer component, here a monitor 10. Monitor 10 as used herein is intended to illustrate any output devices associated with computer systems to provide a display, including, but not limited to, cathode ray tube displays, liquid crystal displays, plasma screens, surface-conduction electron emitter displays, video projector displays, organic light emitting diode displays, and the like. Although the embodiments of the present invention are illustrated as securing to a monitor 10, it is within the scope of the invention to secure task light system 1 to any component known in the art, as may be available within the work space to be illuminated, e.g., monitor, central processing unit, a support for any computer component, a keyboard, a portable computer docking station, a laptop holder, a computer desk, etc.

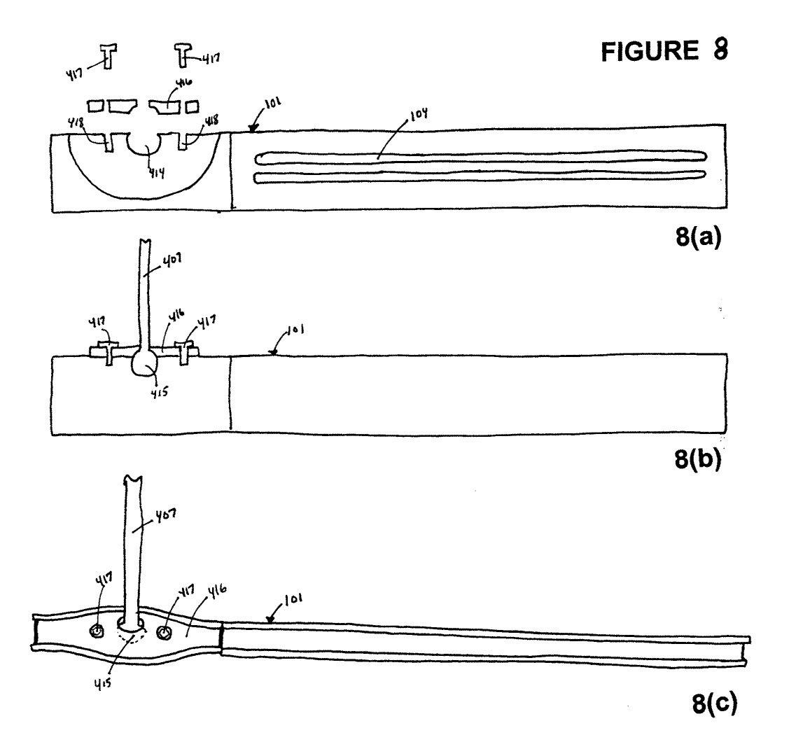

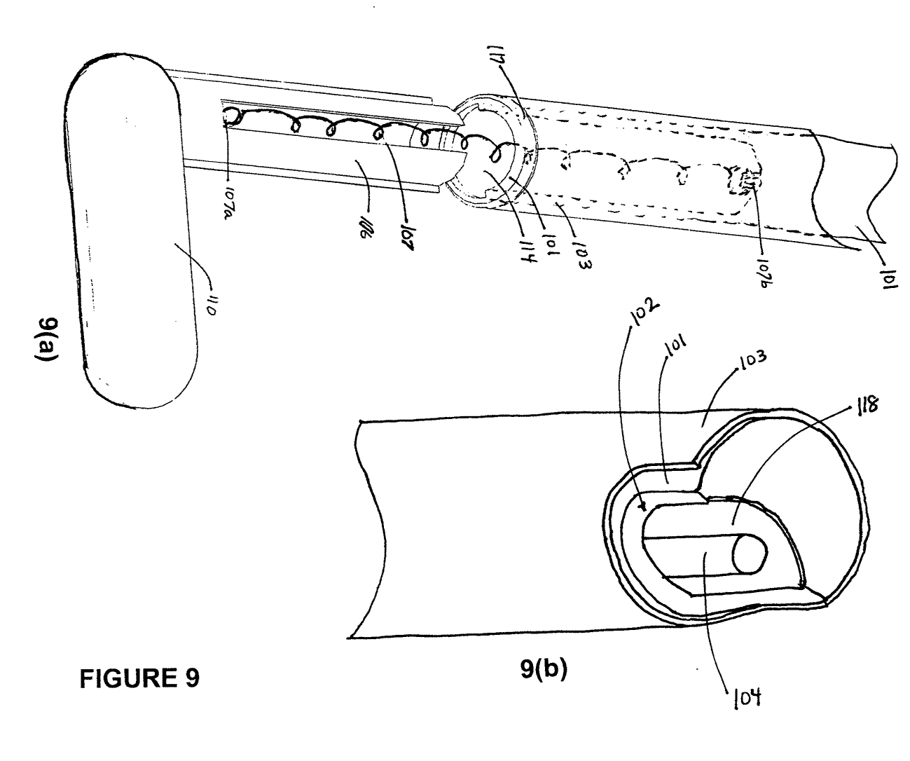

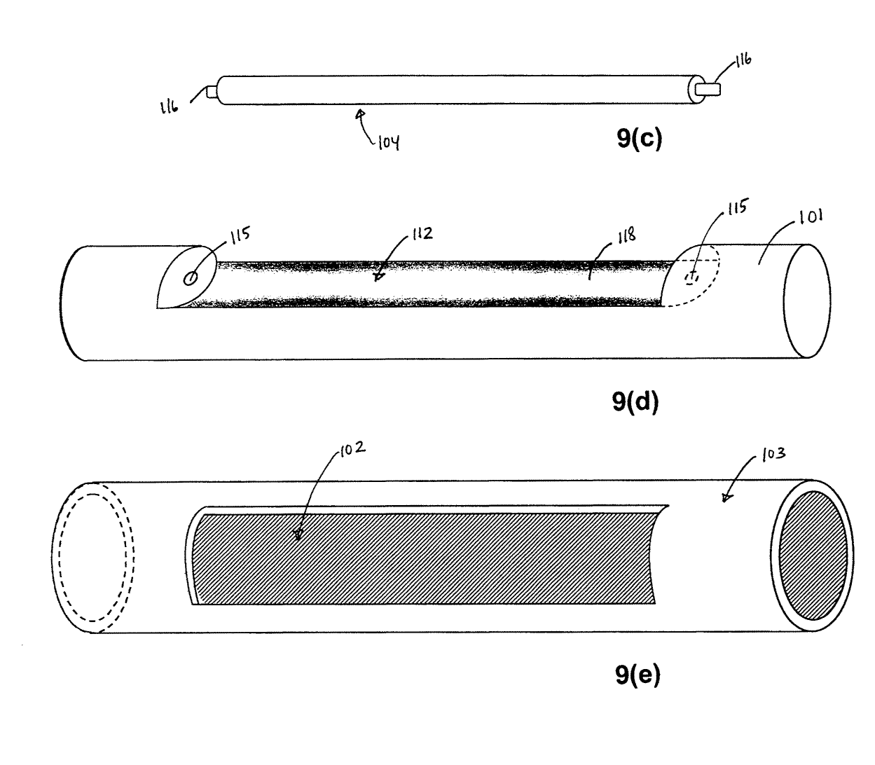

Task light system 1 includes a housing 101, a light source 104 (see FIG. 2), and a mounting structure 5. Mounting structure 5 may be any means by which task light system 1 is secured to monitor 10, preferably including the embodiments described below and shown in FIGS. 1-7. Housing 101 may be of any shape, preferably prismatic or cylindrical with length substantially larger than diameter (as shown in FIG. 9(d)). Housing 101 has a center socket cavity 112. In this embodiment, center socket cavity 112 is shaped to accommodate light source 104, features two female electrical connectors 115 for mating engagement therewith, and may be positioned anywhere on housing 101, preferably longitudinally along housing 101 such that the lengthwise axis of center socket cavity 112 and the lengthwise axis of housing 101 are parallel. As is well known in the art, the surface 118 of center socket cavity 112 is preferably coated with a reflective material for enhanced illumination from light source 104. Light source 104 may be any variety of small light sources known in the art, preferably low voltage fluorescent tubes, and more preferably fluorescent tubes of the cold cathode fluorescent lamp (CCFL) type. Within the scope of the invention, light source 104 may also include light emitting diodes (LED) or other semiconductor devices that emit light. As is well known in the lighting industry, the color temperature of the light source substantially affects the perceived color of an illuminated object. In a preferred embodiment, the color temperature of the light source is in the range from approximately 3000 Kelvins to 6000 Kelvins, which includes incandescent and fluorescent light sources. Also, as is well known in the lighting industry, the illuminance of a light source substantially affects the visibility of the illuminated object. Visibility refers to how well the object can be seen by the human eye. The recommended level of illuminance is dependent on the tasks being performed, the age of the viewer, and other well known factors. In a preferred embodiment of the present invention, the illuminance is in the range from 50 foot candles to 200 foot candles for typical tasks being performed in an office environment or within a worker's task zone. The preferred illuminance level for performance of very prolonged and exacting visual tasks (e.g., watch repair) would be in the range of 500 foot candles to 1000 foot candles. Light source 104 preferably also demonstrates low temperature, low power consumption, high levels of brightness and long lifetimes. Light source 104, as better illustrated in FIG. 9(c), further includes a pair of mating male electrical connectors 116 for mating engagement with female electrical connectors 115 of center socket cavity 112. As better shown in FIG. 8(a), light source 104 may consist of two or more fluorescent bulbs, each connected within central socket cavity 112 in the manner described above. As should be understood by those skilled in the art, it is within the scope of the invention to provide one or more central socket cavities 112 within housing 101 to accommodate any number of light sources desired by a user. Likewise, U-shape or other shaped light sources may be used within central socket cavity 112, and female electrical connections 115 should be placed accordingly to complete the electrical circuit with male connections 116 such that power is provided to light source 104. In a preferred embodiment, light source 104 is interchangeable and the user may select from a variety of light sources to obtain the best color temperature and illuminance for the user's needs.

In some embodiments of the present invention, housing 101 houses an electrical circuit such that when power is supplied to task light system 1, female electrical connectors 115 of center socket cavity 112 are engaged with male electrical connectors 116 of light source 104, and light source 104 is illuminated. The source of power may include an external power supply such as alternating current as provided in most work places through universal wall outlets. In this embodiment, a converter converts alternating current to direct current and supplies this current to housing 101. Alternatively, the external power supply may be the universal serial bus (USB) port of a computer component, or other power sources associated with computer components as are well known by those skilled in the art. In other embodiments, power may be generated by portable commercially available batteries located within the housing or connected to it through electrical circuitry. In the same manner, other sources of power similarly engaged with housing 101 may serve as the external power supply or power source with an appropriate converter and/or connection, e.g. solar energy, mechanical energy and the like.

In the embodiments shown in FIGS. 1-3, task light system 1 further includes a cover 103, which is positioned circumferentially to and may be rotatable about housing 101. Cover 103 is preferably tubular, but may be any elongated shape known in the art. Cover 103 has an aperture 102. Aperture 102 may be shaped in any way that allows light to escape from light source 104, and is preferably shaped to correspond with light source 104 such that when cover 103 is engaged with housing 101, aperture 102 may be positioned directly over light source 104 such that light source 104 maximally radiates light through aperture 102 into the space to be lit by task light system 1. An embodiment of cover 103 is shown in FIG. 9(d). Although only one aperture 102 is shown, it should be understood to one skilled in the art that other aperture configurations, including multiple apertures, could be provided on cover 103 such that rotation of cover 103 upon housing 101 alters and/or adjusts the amount of light from zero light to full illumination from light source 104 to the area surrounding task light system 1.

In operation, a user engages power to task light system 1, and places a document upon a work surface below task light system 1. Light source 104 radiates light through aperture 102 to the work surface below. The user may adjust the level of light illuminating the work surface by rotating cover 103 about housing 101 such that the level of light radiating from aperture 102 changes to a more suitable level. For instance, if the user requires more light, cover 103 may be rotated such that aperture 102 exposes more of light source 104. If the user requires less light, cover 103 may be rotated such that aperture 102 exposes less of light source 104. Although cover 103 and housing 101 should engage such that any position of cover 103 upon housing 101 is maintainable without assistance from any other structures, the engagement between cover 103 and housing 101 preferably presents relatively low friction in operation such that cover 103 may be rotated about housing 101 without substantial effort by a user of task light system 1. Further, cover 103 may be rotated about housing 101 such that aperture 102 is positioned to allow no light to radiate through cover 103 from light source 104 to the work surface. An exploded cross-sectional view of cover 103, housing 101, aperture 102, and light source 104 is presented in FIG. 9(b) for further understanding of the invention.

In an alternate embodiment, a controller may adjust the light radiating from light source 104 onto a work surface. In this embodiment, light radiating from light source 104 exits housing 101 through the aperture defined by central socket cavity 112 at levels of illumination controlled by a controller. The controller may be any type of power regulator as is well known in the art (e.g., a potentiometer). The controller may also be a microprocessor. In such an embodiment, which power may be supplied to light source 104 through a universal serial bus port on a computer component, the component providing such power may be instructed by a user to increase or decrease the power supplied to light source 104 via a USB port, thus adjusting the light illuminating the adjacent work surface. In operation, the user accesses a graphical user interface (GUI) presented by the computer component, the GUI preferably presenting a power selector, for example, a graphical slide bar with a power range from zero percent to one hundred percent. The user may select any power level he desires, using his mouse, keyboard or other input device, and the computer component adjusts the power supplied to task light system 1 via its connection to the component's USB port.

Now referring to the embodiment shown in FIGS. 1 and 2, mounting structure 5 secures task light system 1 to a computer component, e.g. monitor 10. In this embodiment, housing 101 further comprises right and left hollow end slots 114, 113 at each end, which are adapted to receive mounting structure 5 and may be fitted with caps 117 to enhance the appearance of housing 101 and/or to prevent repetitive wear on the ends of housing 101, and left and right internal springs 108, 107, which are mounted within left and right hollow end slots 113, 114 such that mounting structure 5 may engage with housing 101 to secure task light system 1 to monitor 10. Mounting structure 5 includes left and right slider members 105, 106 and left and right end members 109, 110. Slider members 105, 106 are hollow to accommodate springs 108, 107 and are slidably positioned within hollow end slots 113, 114 such that slider members 105, 106 are free to slide along hollow end slots 113, 114 as tension is adjusted within springs 108, 107. As shown in FIG. 9(b), in this embodiment, one end of right spring 107 fastens to right slider member 106 at hook 107a and the opposing end of right spring 107 fastens to housing 101 at hook 107b. Right spring 108 fastens to right slider member 105 in an identical manner. In this embodiment, left and right end members 109, 110 are integrated with slider members 105, 106 such that a user may grasp end members 109, 110 to compress or decompress internal springs 107, 108 to adjust the length of task light system 1 so that it may be secured to monitor 10.

In operation, internal springs 107, 108 are initially at rest and the distance between end members 109, 110 is preferably smaller than the average width of a computer component such as monitor 10. When a user desires to mount task light system 1 upon monitor 10, he grasps end members 109, 110 and pulls each outward such that internal springs 107, 108 uncoil and slider members 105, 106 move outward from housing 101. The user then places task light system against monitor 10 and releases end members 109, 110 such that the recoiling of internal springs 107, 108 tightens task light system 1 in engagement with monitor 10. Once task light system 1 is fitted to monitor 10, internal springs 107, 108 provide sufficient resistance (i.e., compression force) in relation to the weight of task light system 1 to secure the system to monitor 10. An exploded view of spring 107, slider member 106, end member 110, housing 101, cover 103, hollow end slot 114, and plastic end cap 117 in cooperation is shown in FIG. 9(b) for further understanding of the invention. In an alternate embodiment, a single spring 107 may be used, and one end member, i.e., end member 110, may be fixed in place such that, in operation, the opposing end member, i.e., end member 109, may be pulled outward to uncoil spring 107 and provide sufficient compression force to hold the task light system 1 in place.

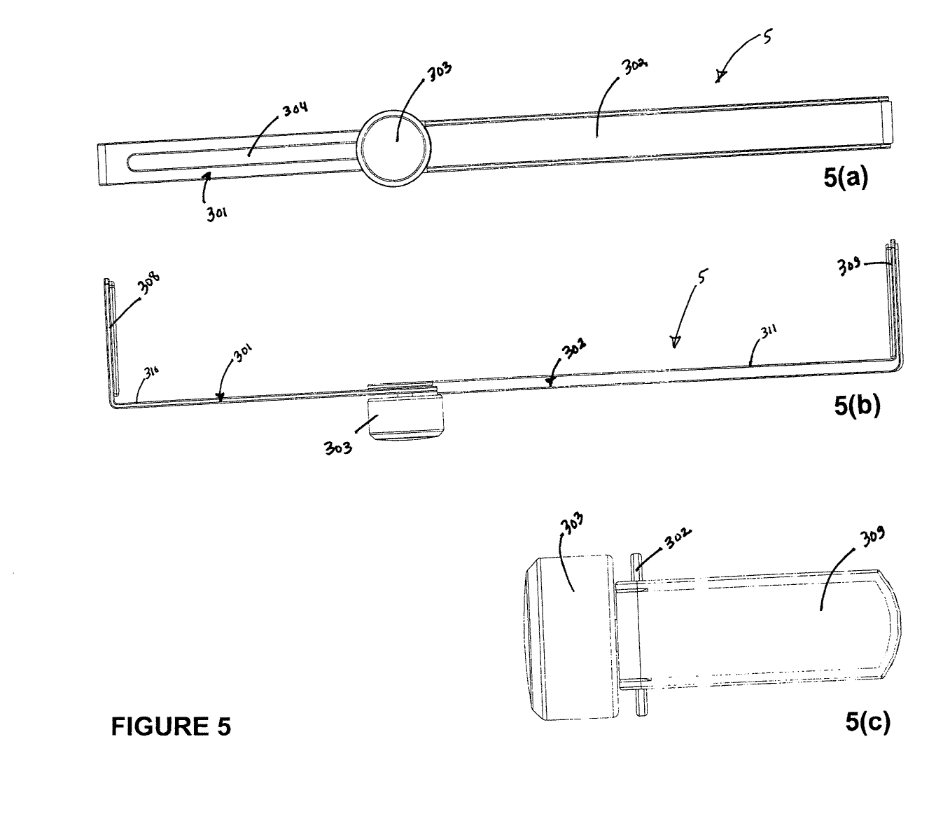

Referring now to the embodiment shown in FIG. 5, mounting structure 5 may include an inner frame member 301, an outer frame member 302, a connector knob 303 and engagement member 307. In this embodiment, housing 101 further comprises sockets 414, 418 for operable engagement with engagement member 407, as described below. Inner frame member 301 is L-shaped, preferably with a relatively shorter bracketing portion 308 and a relatively longer sliding portion 310. Sliding portion 310 includes slot 304. Outer frame member 302 is also L-shaped, preferably with a relatively shorter bracketing portion 309 and a relatively longer hollow receiving portion 311. The interior of hollow receiving portion 311 is adapted for receiving sliding portion 310 of inner frame member 301. Connector knob 303 is preferably a knob with a rod inserted through slot 304 of sliding portion 310 of inner frame member 301 such that the end of the rod is in operable engagement with receiving portion 311. In use, turning the knob clockwise tightens sliding portion 310 of inner frame member 301 against the interior sides of receiving portion 311 of outer frame member 302 such that inner frame member 301 and outer frame member are increasingly immobile relative to each other. Likewise, turning the knob counterclockwise loosens sliding portion 310 of inner frame member 301 from the interior sides of receiving portion 311 of outer frame member 302 such that inner frame member 301 and outer frame member are increasingly mobile relative to each other. Engagement member 307 connects housing 101 to outer frame member 302 by mating engagement with slot 312. Engagement member 307 may consist of a bolt, a flexible mounting joint, or any other type of fixture known in the art that stably engages housing 101 to mounting structure 5.

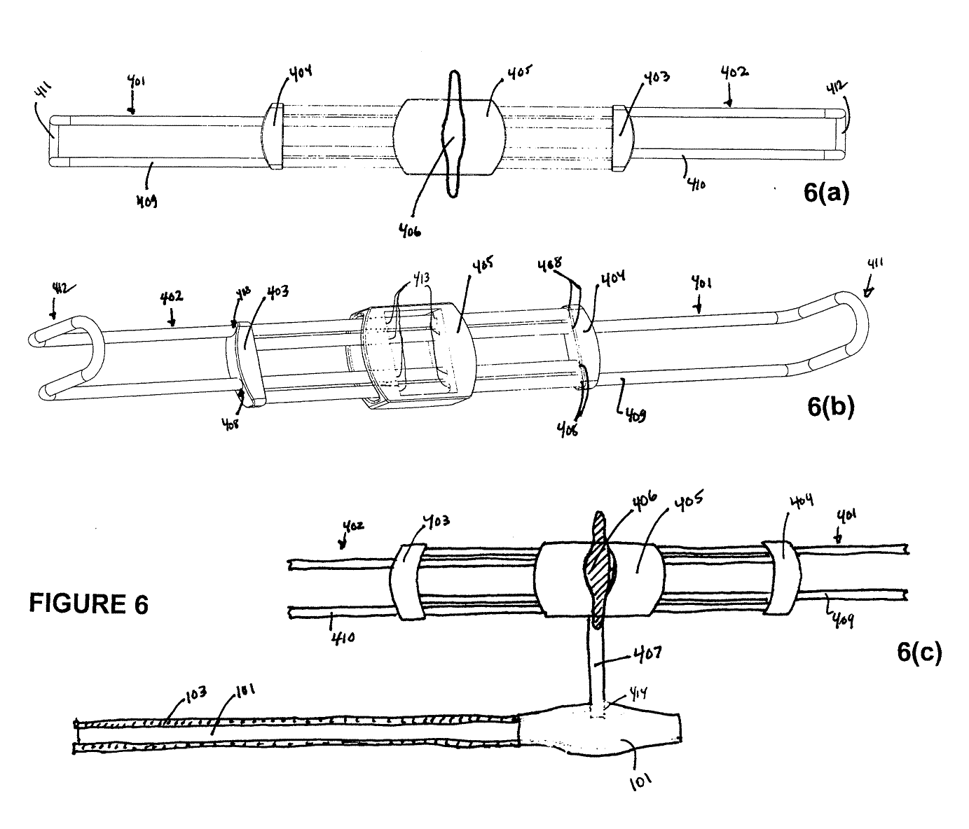

Engagement member 407 connects housing 101 to frame connector 405, by mating engagement with slot 414 as shown in FIG. 6(c). As better illustrated in an embodiment shown in FIG. 8, engagement member 407 comprises an elongated rod, integrally connected to frame connector 405 at any convenient placement, with ball 415. As shown in FIG. 8(a), housing 101 comprises socket 414 for operable engagement with ball 415 to form a ball joint. Ball joint cover 416 comprises slots for pinning screws 417 and engagement member 407 such that ball 415 is securely positioned within socket 414 on housing 101. In operation, as shown in FIG. 8(b), ball 415 inserts into socket 414 and ball joint cover 416 may be placed over ball 415 such that slots 419 align with sockets 418 on housing 101. Two screws 417 may then be driven through slots 419 into sockets 418 to tighten ball joint cover 416 to housing 101. Tightening or loosening of screws 417 provides for adjustment of the flexibility of engagement member 407 within socket 414, and thus the flexibility of housing 101 relative to mounting structure 5. As is well known in the art, engagement member 407 may consist of a ball joint as described, a bolt, other types of flexible mounting joints, or any other type of fixture known in the art that engages housing 101 to mounting structure 5. Preferably, socket 414 and engagement member 407 may be screwed or snap fit together as is well known in the art.

In operation, sliding portion 310 is positioned partially within receiving portion 311 of outer frame member 302. Knob 303 fits through slot 304 and connects to receiving portion 311 to maintain a sufficient distance between inner frame member 301 and outer frame member 302 to allow sliding portion 310 to slide into and out of receiving portion 311. User secures task light system 1 to monitor 10 by adjusting bracketing portions 308, 309 to the frame of monitor 10. Once a fit is achieved, user turns knob 303 clockwise to secure inner frame member 301 and outer frame member 302 together at the desired location such that the tension against monitor 10 through bracketing portions 308, 309 provides support for task light system 1. To remove task light system 1, the user turns knob counterclockwise to loosen inner frame member 301 and outer frame member 302 from each other such that sliding portion 310 may slide outward from receiving portion 311 to release mounting structure 5 from monitor 10.

Referring now to the embodiment shown in FIGS. 6(a)-(c), mounting structure 5 may include a left frame member 401, a right frame member 402, a left frame end piece 403, a right frame end piece 404, a frame connector 405 and an engagement member 407, as described above. In this embodiment, housing 101 further comprises sockets 414, 418 for operable engagement with engagement member 407, as is also fully described above. Each frame member 401, 402 comprises two parallel elements 409, 410 integrated to form an L-shaped member with bracketing portions 411, 412. Frame end pieces 403, 404 are fixed to the ends of elements 409, 410 from respective frame members 401, 402 and further comprise two holes 408 where elements 409, 410 from opposing frame member 402, 401 are allowed to slide through frame end pieces 403, 404 with little resistance. Frame connector 405 may include four bores 413 through which elements 409, 410 slide. Frame end pieces 403, 404 and frame connector 405 thus serve to stabilize the cooperation of frame members 401, 402 and to maintain the alignment of frame members 401, 402 in relation to each other. Knob 406 preferably is a rod in engagement with frame connector 405 such that turning knob 406 clockwise secures elements 409, 410 in relation to frame connector 405 such that left frame member 401 and right frame member 402 cannot slide in relation to each other, and turning knob 406 counterclockwise releases elements 409, 410 so that they may slide through bores 413 of frame connector 405. Engagement member 407 connects mounting structure 5 with housing 1001 in the same manner as the embodiments described in FIGS. 8(a)-(c).

In operation to mount housing 101 to monitor 10, frame end pieces 403, 404 and left and right frame members 401, 402 are assembled in a nested manner such that end pieces 403, 404 and frame connector 405 slide along elements 409, 410 to adjust the width of mounting structure 5 defined by bracketing portions 411, 412. A user adjusts the distance between bracketing portions 411, 412 to fit a computer component, e.g. monitor 10. The user places bracketing portions 411, 412 adjacent to the computer component and turns knob 406 clockwise to secure mounting structure 5.

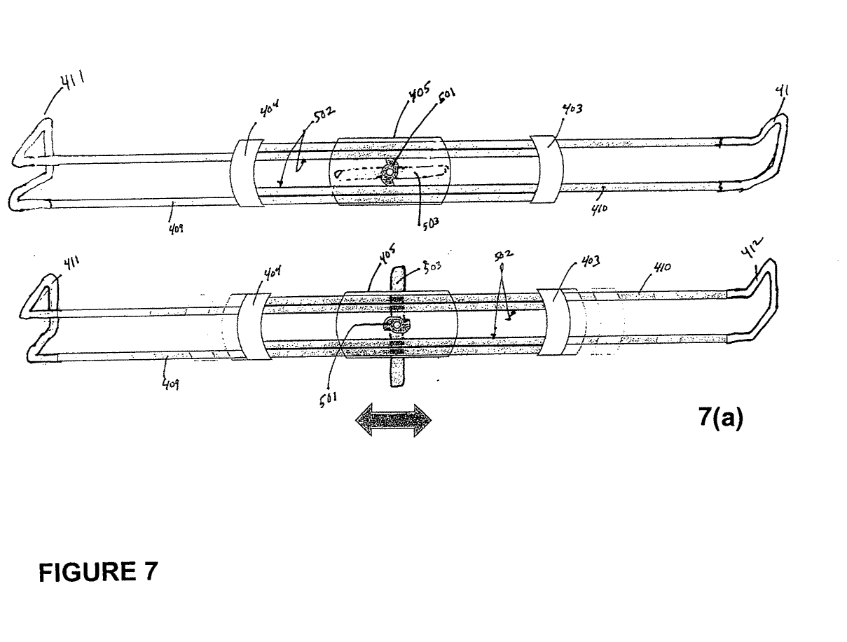

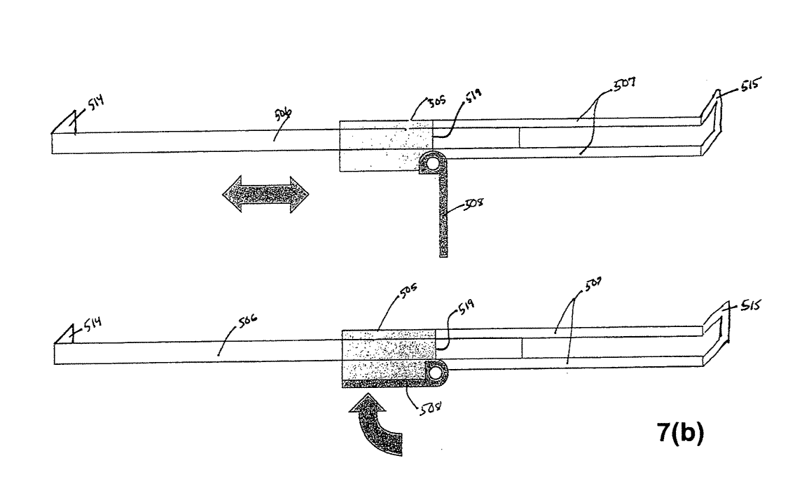

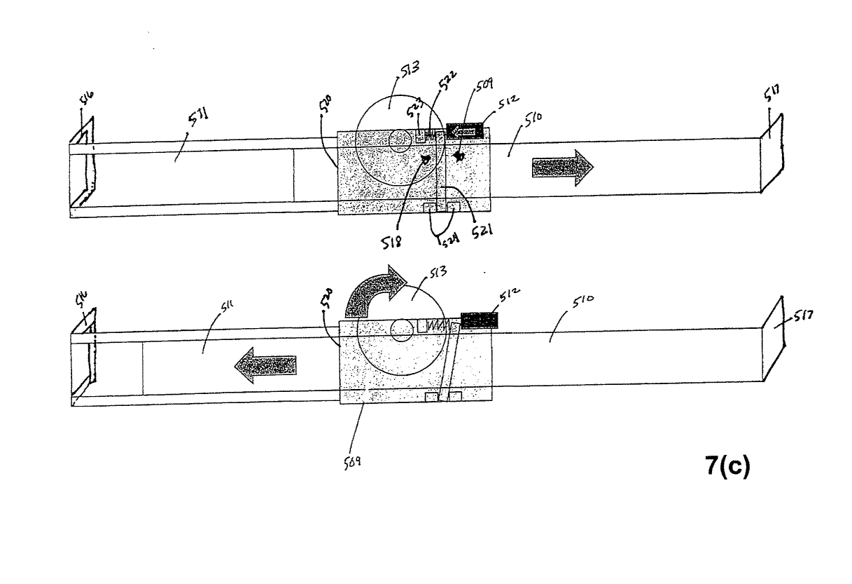

Referring now to the embodiment shown in FIG. 7(a), mounting structure 5 utilizes frame members 401, 402, frame end pieces 403, 404, frame elements 409, 410, frame connector 405 and engagement member 407 as described above. In this embodiment, mounting structure 5 further includes an internal ratchet connector 501, knob 503 and saw tooth edging 502, and housing 101 further comprises sockets 414, 418 for operable engagement with engagement member 407, as also described above. Internal ratchet connector 501 is fixed to the interior of frame connector 405. The inner-most edges of elements 409, 410 include saw tooth edging 502, which cooperates with the saw tooth edges of internal ratchet connector 501. Knob 503 connects through frame connector 405 to the internal ratchet connector 501 such that turning of knob 503 turns ratchet connector 501, which, in turn, moves elements 409, 410 in either direction.

In operation, frame end pieces 403, 404 and left and right frame members 401, 402 are assembled in a nested manner such that end pieces 403, 404 and frame connector 405 slide along elements 409, 410 to adjust the width of mounting structure 5 defined by bracketing portions 411, 412. When knob 503 is turned clockwise, ratcheted engagement between ratchet connector 501 and saw tooth edging 502 causes frame members 401, 402 to move inward to reduce the width of mounting structure 5 (i.e., the distance between bracketing portions 411, 412). When knob 503 is turned counterclockwise, ratcheted engagement between ratchet connector 501 and saw tooth edging 502 causes frame members 401, 402 to move outward to increase the width of mounting structure 5. Frame members 401, 402 are otherwise immobile relative to each other. A user first turns knob 503 counterclockwise such that the distance between bracketing portions 411, 412 is greater than the width of a computer component, e.g. monitor 10. The user then turns knob 503 to decrease the distance between bracketing portions 411, 412 to the point where tension against monitor 10 through bracketing portions 411, 412 secures and provides support for task light system 1.

Referring now to the embodiment shown in FIG. 7(b), mounting structure 5 comprises frame member 506, two frame elements 507, bracketing portions 514, 515 of frame member 506 and frame elements 507, respectively, frame connector 505, engagement member 407 and switch 508. In this embodiment, and as described previously, housing 101 further comprises sockets 414, 418 for operable engagement with engagement member 407. Frame connector 505 has a bore 519 for slidable engagement by frame member 506. Frame elements 507 preferably are fixed in parallel to frame connector 505 at their ends, with sufficient distance between them to accommodate frame member 506. Frame elements 507 may also be integrated into one integral frame unit as two parallel tracks functioning in the same manner as frame elements 507. Frame member 506 slidably engages through frame connector 505 at bore 519 and between frame elements 507 to adjust the distance between bracketing portions 514, 515. Switch 508 is connected, preferably by a hinge and pin, to frame connector 505 such that its open position allows frame member 506 to move slidably through bore 519, and its closed position fixes frame member 506 in relation to frame elements 507 and frame connector 505. Engagement member 407 connects mounting structure 5 with housing 101 in the same manner as the embodiments described in FIGS. 8(a)-(c).

In operation, a user opens switch 508 to slide frame member 506 outward such that the distance between bracketing portions 514, 515 is greater than the width of a computer component, e.g., monitor 10. The user then places bracketing portion 515 adjacent to one side of monitor 10 and slides frame member 506 inward until the tension against monitor 10 through bracketing portions 514, 515 secures and provides support for task light system 1. The user then closes the switch to fix, relative to each other, frame member 506 and frame elements 507 in position.

Referring now to the embodiment shown in FIG. 7(c), mounting structure 5 comprises frame member 510, two frame elements 511, bracketing portions 516, 517 of frame member 510 and frame elements 511, respectively, frame connector 509, spring-actuated lever mechanism 518, and engagement member 407. In this embodiment, housing 101 further comprises sockets 414, 418 for operable engagement with engagement member 407, as described above. Frame connector 509 has a bore 520 for slidable engagement by frame member 510. Frame elements 511 preferably are fixed in parallel to frame connector 509 at their ends, with sufficient distance between them to accommodate frame member 510. Frame elements 511 may also be integrated into one integral frame unit as two parallel tracks functioning in the same manner as frame elements 511. Frame member 510 slidably engages through frame connector 509 through bore 520 and between frame elements 511 to adjust the distance between bracketing portions 516, 517. Spring-actuated lever mechanism 518 includes a spring-actuated button 512, a lever 521, a spring 522, a retaining block 523, two lever blocks 524, and a reset knob 513. One end of lever 521 is fixed to frame connector 509 between retaining blocks 524, and the other end of lever 521 is fixed to spring-actuated button 512. Spring 522 is positioned longitudinally between retaining block 523 and the end of lever 521. When button 512 is pressed toward spring 522, lever 521 compresses spring 522 against retaining block 523, which allows frame member 510 to slide outward to increase the distance between bracketing portions 516, 517. When reset knob 513 is turned clockwise, button 512 is pushed away from spring 522, thus decompressing spring 522 and moving lever 521, which allows frame member 510 to slide inward to decrease the distance between bracketing portions 516, 517. When neither reset knob 513 nor button 512 is engaged, frame member 510 and frame elements 511 are immobile relative to each other. Engagement member 407 connects to housing 101 by mating engagement in the same manner as the embodiments described in FIGS. 8(a)-(c).

In operation, a user substantially simultaneously presses down and slides inward button 512 and slides frame member 510 outward such that the distance between bracketing portions 516, 517 is greater than the width of a computer component, e.g., monitor 10. The user then places bracketing portion 517 adjacent to one side of monitor 10. The user substantially simultaneously turns reset knob 513 and slides frame member 510 inward until the tension against monitor 10 through bracketing portions 516, 517 secures and provides support for task light system 1. The user releases reset knob 513 to fix, relative to each other, frame member 510 and frame elements 511 in position.

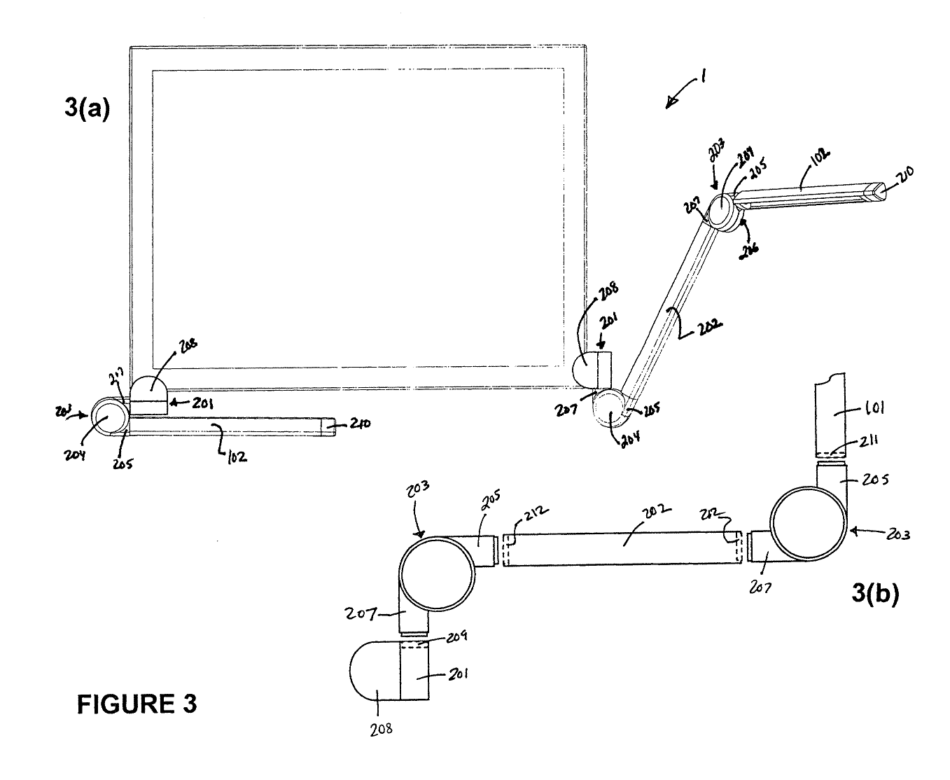

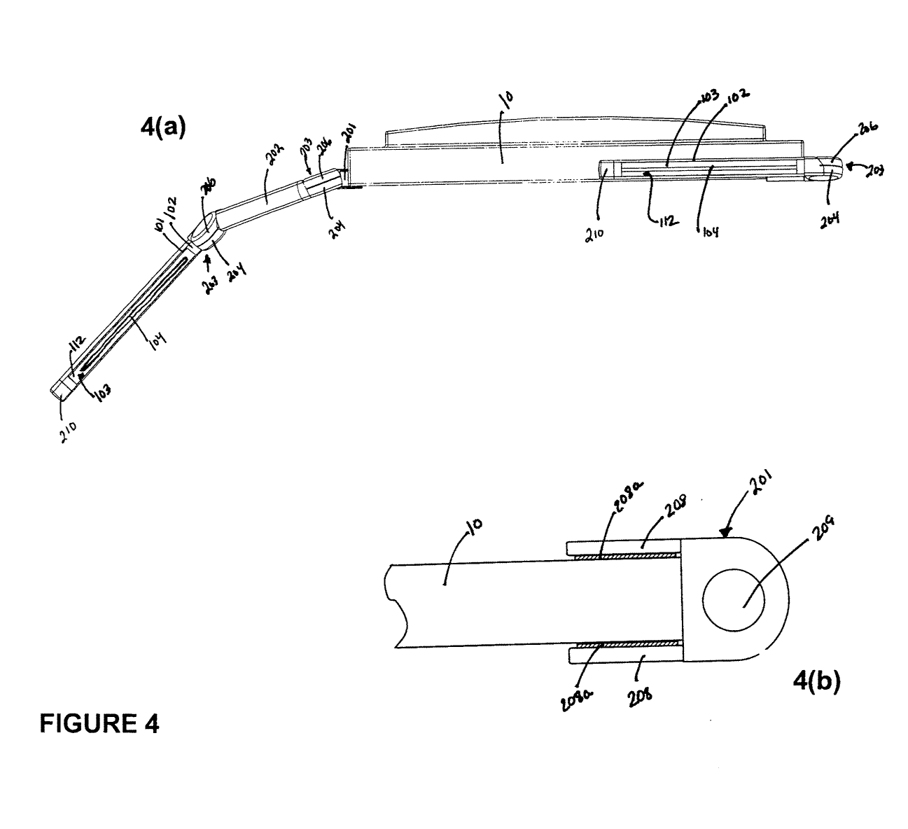

Referring now to the embodiment shown in FIGS. 3 and 4, mounting structure 5 includes one or more connection members 203, a mounting clamp 201, and an optional extension arm member 202. In this embodiment, housing 101 further comprises a hollow end slot 211 and an end cap 210. Connection member 203 may be any means providing articulating engagement between housing 101 and mounting clamp 201, or between arm member 203 and mounting clamp 201. Preferably, connector member 203 consists of a first circular disk 204 with integrated extension member 205 and a second circular disk 206 with integrated extension member 207. First circular disk 204 and second circular disk 206 are fixed together and engaged such that each disk 204, 206 rotates, within the plane of the disks, in substantially opposing directions. Extension member 205 may be engaged with housing 101 or arm member 202. Extension member 207 may be fixed to arm member 202 or mounting clamp 201. Hollow end slot 211 of housing 101 is adapted to receive extension member 205 of connection member 203. It should be understood by those skilled in the art that connection member 203 may connect to housing 101 or arm member 202 or mounting clamp 201 in a variety of well-known ways, including by instead having insertion slots for receipt of protuberances from housing 101, arm member 202, or mounting clamp 201. Therefore, the scope of the present invention includes any such connection member 203 that provides for articulation between housing 101, mounting clamp 201 or optional arm member 202.

Referring still to the embodiment shown in FIGS. 3 and 4, mounting clamp 201 includes two grasping faces 208 generally forming a flexible U with clamp 201, wherein grasping faces 208 grasp the frame of monitor 10 at any location to secure task light system 1. Grasping faces preferably include an additional rubber or soft, flexible layer 208a for better grasping without concern for damage to monitor 10. Mounting clamp 201 also may include a slot 209 for insertion of extension member 207. Arm member 202 may be any elongated shape known in the art, and comprises two hollow end slots 212, which allow for insertion of extension members 205 or 207. Arm member 202 connects two connector members 203 or connects connector member 203 to mounting claim 201. To assemble mounting structure 5, as shown in the embodiment in FIG. 3(b), extension member 205 of connection member 203 engages with housing 101 by insertion into hollow end slot 211. Arm member engages with and spans between connection members 203, and extension members 205, 207 insert into hollow end slots 212 to form an articulating arm connected to housing 101 as described. Extension member 207 of connection member 203 then inserts into slot 209 of mounting clamp 201. It should be understood to those skilled in the art that multiple arm members 202 and connection members 203 may be incorporated into the structure of task light system 1 such that further articulation of task light system 1 is accomplished in a like manner.

In operation, mounting clamp 201 is secured to a computer component, e.g., monitor 10, by wedging grasping faces 208 around the frame of monitor 10 such that grasping faces 208 engage with monitor 10 and secure mounting clamp 201 to monitor 10, as shown in FIG. 4(b). Extension member 207 may rotate within slot 209 about the axis of insertion into slot 209. Through mounting clamp 201, connection members 203 and optional arm members 202, the positioning of task light system 1 is further adjustable to accommodate work spaces of a variety of dimensions, or for multiple users with varying requirements for contrast or illumination.

It should be appreciated by those skilled in the art that a variety of materials could be selected for construction of the components of task light system 1 within the scope of the present invention. The task light system 1 of the present invention is preferably light and rugged. For instance, housing 101 may be constructed of plastic, aluminum or another light metal. Cover 103 may be constructed of plastic, aluminum or a light metal, provided that rotation of the cover may be done easily by a user. Mounting structure 5 may be constructed of aluminum frames or plastic component parts, or any other materials suitable for their construction such that task light system 1 may be secured to computer components like monitor 10. Although cold cathode fluorescent lamps may provide high levels of brightness, low levels of power consumption, and low temperatures in use, other types of lamps or bulbs are within the scope of the invention, including conventional fluorescent bulbs.

It should further be appreciated by those skilled in the art that engagement member 407 may be engaged with housing 101 in a variety of ways, including those described above. The scope of the invention includes any such method for engagement provided housing 101 secures to mounting structure 5. Moreover, mounting structure 5 is not limited to those embodiments described above, and should be understood to be any means for mounting task light system 1 to a structural device within a worker's task zone, including all embodiments described herein, as well as more conventional means such as adhesive double sided tape applied to housing 101, mounting hooks, Velcro™ hook and loop fabric, and the like.

The above description discloses several embodiments of the present invention. Many modifications to the invention could be made beyond those modifications already described. Those skilled in the art will recognize that many variations, modifications or optional features could be made without departing from the basic inventive concept. All such variations, modifications, and/or optional features are intended to come within the scope of the following claims.

What is claimed is:

1. A task light system, comprising (a) a housing having at least one aperture; (b) a light means positioned within the housing adjacent the aperture; (c) a mounting means wherein the mounting means operably engages the housing and is adapted to be removably attached to a structural device in a worker's task zone.

2. The task light system of claim 1 further comprising a light control means operably engaged to the light means.

3. The task light system of claim 2 wherein the light control means comprises a cover movably connected to the housing, and wherein the cover may be moved to eclipse the aperture in any segment of the range from zero percent to one-hundred percent.

4. The task light system of claim 3 wherein the cover rotates about the housing.

5. The task light system of claim 2 wherein the light control means comprises a potentiometer.

6. The task light system of claim 2 wherein the light control means comprises a microprocessor.

7. The task light system of claim 6 wherein the user adjusts the light level using a graphic user interface (GUI).

8. The task light system of claim 1 wherein the light means comprises one or more fluorescent light bulbs.

9. The task light system of claim 8 wherein the one or more fluorescent light comprise one or more cold cathode fluorescent light bulbs.

10. The task light system of claim 1 wherein the light means comprises one or more light emitting diodes.

11. The task light system of claim 1 wherein the light means comprises a light source with a color temperature in the range from approximately 3000 Kelvins to approximately 6000 Kelvins.

12. The task light system of claim 1 wherein the light means comprises a light source with an illuminance in the range from approximately 50 foot candles to approximately 200 foot candles.

13. The task light system of claim 1 wherein the housing includes a reflective interior surface.

14. The task light system of claim 1 wherein the light means comprises a power source operably engaged to the light source.

15. The task light system of claim 14 wherein the power source is external to the housing.

16. The task light system of claim 14 wherein the power source converts alternating current to direct current.

17. The task light system of claim 14 wherein the power source comprises a computer component.

18. The task light system of claim 17 wherein the power source is supplied by the computer component via a universal serial bus (USB) port.

19. The task light system of claim 14 wherein the power source converts solar energy to electrical power.

20. The task light system of claim 14 wherein the power source comprises one or more batteries.

21. The task light system of claim 1 wherein the mounting means secures the task light system to a computer component.

22. The task light system of claim 21 wherein the computer component comprises a monitor.

23. The task light system of claim 21 wherein the computer component comprises a central processing unit.

24. The task light system of claim 21 wherein the computer component comprises a support for a monitor.

25. The task light system of claim 21 wherein the computer component comprises a support for a central processing unit.

26. The task light system of claim 21 wherein the mounting means comprises an engagement means to secure the housing to the mounting means.

27. The task light system of claim 26 wherein the engagement means releasably secures the housing to the mounting means.

28. The task light system of claim 27 wherein the engagement means comprises a flexible ball joint adapted to secure the housing to the mounting means.

29. The task light system of claim 27 wherein the engagement means rotatably secures the housing to the mounting means.

30. The task light system of claim 26 wherein the mounting means further comprises (a) an inner frame member, the inner frame member having a slot; (b) a substantially hollow outer frame member for receiving the inner frame member to adjust a width of the task light system; and (c) a locking adjustment means to cooperate with the inner and outer frame members through the slot to adjust the width of the task light system.

31. The task light system of claim 30 wherein the adjustment means comprises a knob adapted to tighten and loosen the inner and outer frame members relative to each other.

32. The task light system of claim 26 wherein the mounting means comprises (a) two frame members; and (b) a connector means to adjust a width of the task light system.

33. The task light system of claim 32 wherein the connector means comprises two frame end members and a frame connector member operably engaged with the frame members.

34. The task light system of claim 33 wherein the connector means further comprises an adjustment means to cooperate with the frame members through the frame connector member to adjust the width of the task light system.

35. The task light system of claim 34 wherein the adjustment means comprises a knob adapted to immobilize or mobilize the frame members relative to each other.

36. The task light system of claim 34 wherein the frame connector member further comprises an internal ratchet connector, wherein the frame members include at least one saw-tooth edge which is operably engaged with the internal ratchet connector, and the adjustment means operably engages the ratchet connector to adjust the width of the task light system.

37. The task light system of claim 36 wherein the adjustment means comprises a knob engaged with the ratchet connector to turn the ratchet connector clockwise or counterclockwise.

38. The task light system of claim 34 wherein the adjustment means comprises a spring button and a reset knob, whereby the spring button operates to allow movement of the frame members to increase the width of task light system, whereby the reset knob operates to allow movement of the frame members to decrease the width of task light system, and whereby frame members are substantially immobile relative to each other otherwise.

39. The task light system of claim 34 wherein the adjustment means further comprises a switch, whereby when the switch is open, the engagement between the frame members is adjustable, and when the switch is closed, the frame members are substantially immobile relative to each other.

40. The task light system of claim 26 wherein the mounting means comprises at least two members spring-mounted to the housing and capable of exacting opposing forces such that a compression force secures the task light system to computer component.

41. The task light system of claim 26 wherein the mounting means comprises at least one connector member movably attached to a mounting clamp.

42. The task light system of claim 41 wherein the connector member comprises two disks fixed together and rotatable in substantially opposing directions.

43. The task light system of claim 41 wherein the connector member engages and articulates the housing and the mounting clamp relative to each other.

44. The task light system of claim 41 wherein the mounting means further comprises at least two connector members movably attached to at least one arm member.

45. The task light system of claim 44 wherein the connector members engage and articulate the arm member, the housing, and the mounting clamp relative to each other.

46. The task light system of claim 41 wherein the mounting clamp removably secures the task light system to a computer component.

47. The task light system of claim 46 wherein the mounting clamp secures the task light system to a monitor.

48. The task light system of claim 46 wherein the mounting clamp secures the task light system to a central processing unit.

49. The task light system of claim 46 wherein the mounting clamp secures the task light system to a support for a monitor.

50. The task light system of claim 46 wherein the mounting clamp secures the task light system to a support for a central processing unit.

51. A task light system, comprising (a) a housing with an aperture; (b) at least one light source within the housing and adjacent the aperture, and (c) a mounting structure, wherein the mounting structure engages the housing.

52. The task light system of claim 51 further comprising a light controller operably engaged to the light source.

53. The task light system of claim 52 wherein the light controller comprises a cover.

54. The task light system of claim 53 wherein the cover is movably connected to the housing, and wherein the cover may be moved to eclipse the aperture in any segment of the range from zero percent to one-hundred percent.

55. The task light system of claim 54 wherein the cover rotates about the housing.

56. The task light system of claim 52 wherein the light controller comprises a potentiometer to control the light source.

57. The task light system of claim 52 wherein the light controller comprises a microprocessor.

58. The task light system of claim 51 wherein the user adjusts the light level using a graphic user interface (GUI).

59. The task light system of claim 51 wherein the light source comprises one or more fluorescent light bulbs.

60. The task light system of claim 59 wherein the one or more fluorescent light bulbs comprise one or more cold cathode fluorescent light bulbs.

61. The task light system of claim 51 wherein the light source comprises one or more light emitting diodes.

62. The task light system of claim 51 wherein the light source comprises a color temperature in the range from approximately 3000 Kelvins to approximately 6000 Kelvins.

63. The task light system of claim 51 wherein the light source has an illuminance in the range from approximately 50 foot candles to approximately 200 foot candles.

64. The task light system of claim 51 wherein the housing includes a reflective interior surface.

65. The task light system of claim 51 wherein the mounting structure secures the task light system to a computer component.

66. The task light system of claim 65 wherein the computer component comprises a monitor.

67. The task light system of claim 65 wherein the computer component comprises a central processing unit.

68. The task light system of claim 65 wherein the computer component comprises a support for a monitor.

69. The task light system of claim 65 wherein the computer component comprises a support for a central processing unit.

70. The task light system of claim 51 further comprising a power source.

71. The task light system of claim 70 wherein the power source is external to the housing.

72. The task light system of claim 70 wherein the power source converts alternating current power to direct current.

73. The task light system of claim 70 wherein the power source comprises a computer component.

74. The task light system of claim 73 wherein the power source is supplied by the computer component via a universal serial bus (USB) port.

75. The task light system of claim 70 wherein the power source converts solar energy to electrical power.

76. The task light system of claim 70 wherein the power source comprises one or more batteries.

77. The task light system of claim 51 wherein the mounting structure comprises an adhesive.

78. A task light system kit comprising (a) a plurality of interchangeable mounting structures and (b) a light source adapted to be removably attached to one of the plurality of interchangeable mounting structures, wherein the plurality of interchangeable mounting structures are adapted to removably attach the light source to a structural device in the worker's task zone.

79. The task light system kit of claim 78 further comprising a universal serial bus (USB) cable to connect the light source to a computer component's USB port.

80. The task light system kit of claim 79 further comprising graphical user interface software adapted to allow a user to adjust the power supplied to the computer component's USB port.

81. A task light system kit comprising (a) a mounting structure and (b) a plurality of interchangeable light sources adapted to be removably attached to the mounting structure, wherein the plurality of interchangeable light sources are adapted to provide adequate lighting for a variety of tasks in the worker's task zone.

82. The task light system kit of claim 81 further comprising a universal serial bus (USB) cable to connect the light source to a computer component's USB port.

83. The task light system kit of claim 82 further comprising graphical user interface software adapted to allow a user to adjust the power supplied to the computer component's USB port.
